(19) United States
(12) Patent Application Publication
(10) Pub. No.: US 2021/0319376 A1
(43) Pub. Date: Oct. 14, 2021

(54) RESOURCE ALLOCATION METHOD AND APPARATUS, AND ELECTRONIC DEVICE

(71) Applicant: Advanced New Technologies Co., Ltd., Grand Cayman (KY)

(72) Inventor: Zhi LI, Hangzhou (CN)

(21) Appl. No.: 17/357,796

(22) Filed: Jun. 24, 2021

Related U.S. Application Data
(63) Continuation of application No. PCT/CN2019/119326, filed on Nov. 19, 2019.

(30) Foreign Application Priority Data
Jan. 29, 2019 (CN) 201910088767.7

(51) Int. Cl. G06Q 10/06; G06Q 30/02; G06F 17/18

(52) U.S. Cl. CPC G06Q 10/0635; G06F 17/18; G06Q 30/0201; G06Q 10/06312

(57) ABSTRACT

Implementations of the present specification provide a resource allocation method and apparatus, and an electronic device. The method includes: obtaining resource data of a user; calculating a risk preference coefficient of the user based on the resource data of the user; calculating a maximum utility value of a utility function by using the risk preference coefficient; and determining a resource allocation ratio of the user based on the obtained maximum utility value, so as to configure a resource combination solution that meets actual needs of the user.

### BACKGROUND

### Technical Field

The present specification relates to the field of computing, and in particular, to data processing and planning.

### Description of the Related Art

Resource allocation refers to managing and planning asset allocation of a user among different asset categories based on user needs and risk attributes. When resources are assets, according to Markowitz's portfolio theory, rational people are risk-averse. If two assets have the same expected return, people will choose the one with the lower risk, and only when the higher expected return is obtained, will people bear the higher risk. With the increasing abundance of categories of assets, users are facing a wide variety of choices in allocating the resources.

### BRIEF SUMMARY

Implementations of the present specification provide a resource allocation method and apparatus, and an electronic device to alleviate the problems of high resource allocation threshold, low efficiency, and low accuracy in the existing technologies.

A resource allocation method according to some implementations of the present specification includes: collecting resource data of a user, the resource data including first risk resource data and second risk resource data of the user, a proportion of the first risk resource data in total resource data, and a proportion of the second risk resource data in the total resource data; calculating a risk preference coefficient of the user based on the first risk resource data and the second risk resource data of the user, the proportion of the first risk resource data in the total resource data, and the proportion of the second risk resource data in the total resource data; and calculating a maximum utility value of a utility function based on a utility function model and by using the risk preference coefficient as an input parameter, and determining a resource allocation ratio of the user based on the obtained maximum utility value.

In some implementations, before the collecting the resource data of the user, the method further includes: determining the user based on a screening rule, the screening rule including: users whose total frequency of purchasing or redeeming investment products is greater than a predetermined number of times, and users who invest in a number of categories of products greater than a predetermined number.

In some implementations, in the method, the resource data includes asset data, and the calculating the risk preference coefficient of the user based on the first risk resource data and the second risk resource data of the user, the proportion of the first risk resource data in the total resource data, and the proportion of the second risk resource data in the total resource data specifically includes: calculating the risk preference coefficient of the user based on the following formula:

$$ARA = \frac{E [ R ] - 1}{W * x * Var [ R ]}$$

where ARA denotes the risk preference coefficient; E[R] denotes an expected return rate of total assets; W denotes total asset data; x denotes a proportion of first risk asset data in the total asset data and a proportion of second risk asset data in the total asset data; and Var [R] denotes the variance of the total asset data.

In some implementations, in the method, the calculating the maximum utility value of the utility function based on the utility function model and by using the risk preference coefficient as the input parameter specifically includes: calculating the maximum utility value of the utility function based on the following formula:

max U(W_{*},ARA)

where W_{*} denotes an allocation ratio of an optimal first risk asset; and ARA denotes the risk preference coefficient.

In some implementations, in the method, the determining the resource allocation ratio of the user based on the obtained maximum utility value includes: using the obtained W_{*} as a proportion of the optimal first risk asset of the user in the total assets; and using 1−W_{*} as a proportion of an optimal second risk asset of the user in the total assets.

In some implementations, the method further includes: determining a proportion of each risk investment product in the optimal first risk asset.

In some implementations, in the method, the determining the proportion of each risk investment product in the optimal first risk asset includes: obtaining net value data of all risk investment products, determining an expected return rate and covariance matrix of each risk investment product, and solving an objective function by using a mean-variance model to obtain the proportion of each risk investment product in the optimal first risk asset.

In some implementations, in the method, the solving the objective function by using the mean-variance model to obtain the proportion of each risk investment product in the optimal first risk asset specifically includes solving the objective function based on the following formula:

where the objective function is:

$$max \frac{{\sum }_{i = 1}^{N} {w}_{i} {u}_{i} - {r}_{f}}{\sqrt{{\sum }_{i , j = 1}^{N} {σ}_{i j} {w}_{i} {w}_{j}}}$$

a limitation on the objective function is:

$$S . t . {\sum }_{i = 1}^{N} {w}_{i} = 1$$

where wᵢ denotes a weight of risk investment product i; wⱼ denotes a weight of risk investment product j; uᵢ denotes an expected return rate of risk investment product i; r_{f} denotes a return of the optimal second risk asset; and σᵢⱼ denotes the covariance between the expected return rates of risk investment products i and j.

Some implementations of the present specification provide a resource allocation apparatus, including: a collection module, configured to collect resource data of a user, the resource data including first risk resource data and second risk resource data of the user, a proportion of the first risk resource data in total resource data, and a proportion of the second risk resource data in the total resource data; a calculation module, configured to calculate a risk preference coefficient of the user based on the first risk resource data and the second risk resource data of the user, the proportion of the first risk resource data in the total resource data, and the proportion of the second risk resource data in the total resource data; and a first determining module, configured to calculate a maximum utility value of a utility function based on a utility function model and by using the risk preference coefficient as an input parameter, and determine a resource allocation ratio of the user based on the obtained maximum utility value.

In some implementations, the apparatus further includes a screening module, configured to determine the user based on a screening rule before the resource data of the user is collected, the screening rule including: users whose total frequency of purchasing or redeeming investment products is greater than a predetermined number of times, and users who invest in a number of categories of products greater than a predetermined number.

In some implementations, in the apparatus, the resource data includes asset data, and the calculation module is specifically configured to calculate the risk preference coefficient of the user based on the following formula:

$$ARA = \frac{E [ R ] - 1}{W * x * Var [ R ]}$$

where ARA denotes the risk preference coefficient; E[R] denotes an expected return rate of total assets; W denotes total asset data; x denotes a proportion of first risk asset data in the total asset data and a proportion of second risk asset data in the total asset data; and Var [R] denotes the variance of the total asset data.

In some implementations, in the apparatus, the first determining module is specifically configured to calculate the maximum utility value of the utility function based on the following formula:

max U(W_{*},ARA)

where W_{*} denotes an allocation ratio of an optimal first risk asset; and ARA denotes the risk preference coefficient.

In some implementations, in the apparatus, the first determining module is further configured to use the obtained W_{*} as a proportion of the optimal first risk asset of the user in the total assets; and use 1−W_{*} as a proportion of an optimal second risk asset of the user in the total assets.

In some implementations, the apparatus further includes a second determining module, configured to determine a proportion of each risk investment product in the optimal first risk asset.

In some implementations, in the apparatus, the second determining module is specifically configured to: obtain net value data of all risk investment products, determine an expected return rate and covariance matrix of each risk investment product, and solve an objective function by using a mean-variance model to obtain the proportion of each risk investment product in the optimal first risk asset.

In some implementations, in the apparatus, the second determining module is further configured to solve the objective function based on the following formula: where the objective function is:

$$max \frac{{\sum }_{i = 1}^{N} {w}_{i} {u}_{i} - {r}_{f}}{\sqrt{{\sum }_{i , j = 1}^{N} {σ}_{i j} {w}_{i} {w}_{j}}}$$

a limitation on the objective function is:

$$S . t . {\sum }_{i = 1}^{N} {w}_{i} = 1$$

where wᵢ denotes a weight of risk investment product i; wⱼ denotes a weight of risk investment product j; uᵢ denotes an expected return rate of risk investment product i; r_{f} denotes a return of the optimal second risk asset; and σᵢⱼ denotes the covariance between the expected return rates of risk investment products i and j.

An electronic device according to an implementation of the present specification includes a memory, a processor, and a computer program that is stored in the memory and can run on the processor, where the processor implements the above resource allocation method when executing the program.

At least one technical solution provided in the implementations of the present application can achieve the following beneficial effects:

Using a technical solution of the present specification, characteristics of a user, such as a return need, a risk preference, and a risk tolerance are all collected as data set and analyzed using models, and the resources of the user can be managed and planned in a tailored way that suits the characteristics of the user. Further, the tailored resource management and planning of the user resources will be conducted more efficiently and timely because no face-to-face interactions are involved and no user input is involved. Instead, existing and/or historical resource data of a user is obtained, and a risk preference coefficient of the user is calculated based on the existing and/or historical resource data of the user. A maximum utility value of a utility function is calculated by using the risk preference coefficient, and a resource allocation ratio of the user is determined based on the obtained maximum utility value. Based on the solution, the risk-return preference of the user can be determined based on the current or historical asset allocation status of the user, so a portfolio solution meeting the actual needs or preference of the user can be delivered. Therefore, the asset allocation management is conducted more efficiently in a customized way, which is also convenient for the user. Further, the tailored resource allocation and management result is more accurate with respect to a specific user because no human input or human error and bias is involved in the decision making of resource allocation decision making.

### BRIEF DESCRIPTION OF THE SEVERAL VIEWS OF THE DRAWINGS

To describe the technical solutions in the implementations of the present specification or in the existing technologies more clearly, the following briefly describes the accompanying drawings needed for describing the implementations or the existing technologies. Clearly, the accompanying drawings in the following descriptions merely show some implementations of the present specification, and persons of ordinary skill in the art can still derive other drawings from these accompanying drawings without innovative efforts.

FIG. 1 is a schematic diagram illustrating an overall platform architecture involved in an actual application scenario of solutions of the present specification.

FIG. 2 is a schematic flowchart illustrating a resource allocation method according to an implementation of the present description.

FIG. 3 is a schematic flowchart of combining an optimal first risk asset according to an implementation of the present specification.

FIG. 4 is a schematic structural diagram illustrating a resource allocation apparatus according to an implementation of the present description.

### DETAILED DESCRIPTION

To enable persons skilled in the art to better understand technical solutions in the present specification, the following clearly and comprehensively describes the technical solutions in the implementations of the present specification with reference to accompanying drawings in the implementations of the present specification. Clearly, the described implementations are merely some rather than all of the implementations of the present application. Based on the implementations of the present specification, all other implementations obtained by persons of ordinary skill in the art without innovative efforts shall fall in the protection scope of the present application.

The following describes the technical solutions of the present application in detail by taking a specific implementation scenario as an example. The following implementations are described by using a user asset as resource data. However, the resource data in the present application is not limited to an asset, and the replacement of the resource data with user asset data is only an implementation of the present application.

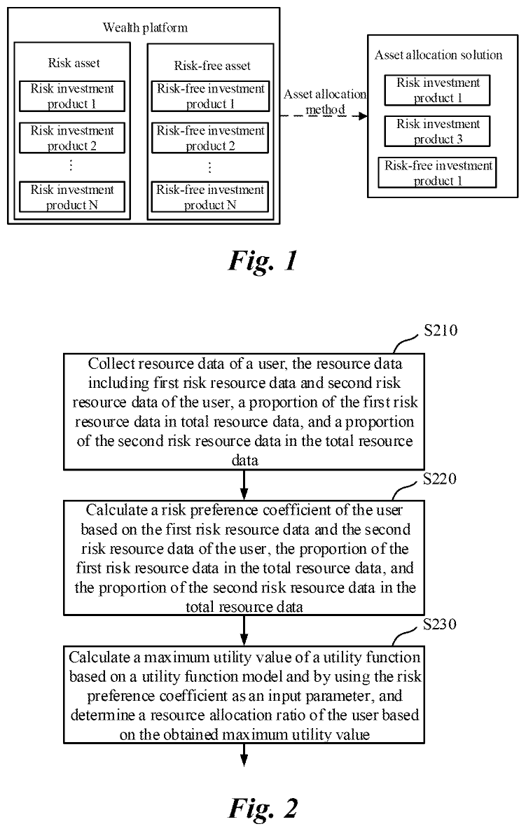

FIG. 1 is a schematic diagram illustrating an example platform architecture involved in an actual application scenario of solutions of the present specification. The overall platform architecture includes at least one wealth platform. The wealth platform mainly contains risk assets and risk-free assets. Example risk assets include assets that are likely to be lost in investment, such as stocks, funds, bonds, and loans. Risk-free assets generally refer to assets that can generate benefits in investment, but there is no risk, such as short-term treasury bonds, commercial instruments, and large deposit certificates. In the implementations of the present specification, for example, a one-year deposit is taken as the risk-free asset, and the return rate of the risk-free asset is the one-year deposit interest rate. It should be noted that the risk assets and the risk-free assets can be expressed as large-category assets such as stocks, bonds, and products, or can be expressed as a specific wealth management product. In the solution, because asset data of a user needs to be obtained, the wealth platform can provide a data collection function. Or the source of the data can be replaced with a third-party database, and the wealth platform is not required to implement data collection. The main function of the wealth platform is to collect the asset status of the user. In implementations, other platforms can be used instead of the wealth platform to implement the above function, such as a fund distribution platform, a conventional bank platform, and a wealth management platform provided by a securities firm. Therefore, the wealth platform does not constitute a limitation on the application scenario of the solution. By using the asset allocation method of the present specification, a risk investment product and a risk-free investment product that the user already holds are optimally configured based on the wealth platform, so the actual investment demand of the user can be more accurately reflected.

The following describes in detail the solutions of the present specification based on the above scenario.

FIG. 2 is a schematic flowchart illustrating a resource allocation method according to an implementation of the present description. The method can specifically include the following steps:

Step S210: Collect resource data of a user, the resource data including first risk resource data and second risk resource data of the user, a proportion of the first risk resource data in total resource data, and a proportion of the second risk resource data in the total resource data. The resource data may indicate various characteristics, attributes or parameters of the resources. In some implementations, the resource data indicates the monetary values of the resources. In the description herein, monetary value of a resource is used as an illustrative example of resource data. It should be appreciated that resource data may indicate other characteristics, attributes or parameters of resources, which are all included in the scope of the disclosure.

In one or more implementations of the present specification, asset data of the user can be obtained through a wealth platform, where the asset data can include first risk asset data and second risk asset data of the user, a proportion of the first risk asset data in total asset data, and a proportion of the second risk asset data in the total asset data. In implementations, when a risk value of the second risk asset data is lower than that of the first risk asset data, the second risk asset data can also be referred to as a risk-free asset, in which case the first risk asset data is referred to as a risk asset. In the following implementation, the first risk asset data is replaced with the risk asset, and the second risk asset data is replaced with the risk-free asset. By obtaining the asset data of the user, it is possible to learn the current asset status of the user, and further infer the current risk-return preference of the user based on the current asset status of the user.

Further, before the asset data of the user is obtained, some of the user characteristic data can be determined based on a screening rule, where the screening rule can include: users whose total frequency of purchasing or redeeming investment products is greater than a predetermined number of times, and users who invest in a number of categories of products greater than a predetermined number. It should be noted that in the description herein, the term “predetermined number” does not mean that such a number is fixed or cannot be updated or changed. The term “predetermined” includes the scenarios that a parameter, a number, a threshold or a condition is dynamically or experimentally determined. Before the asset data of the user is obtained, valid users who are more active in investment and wealth management and richer in categories of investment and wealth management products are selected. In an implementation, the valid users can refer to users that have purchased or redeemed investment products more than 10 times and have more than three categories of investment products in the past year. By screening the valid user, the interference of an invalid user on the asset allocation result is avoided. However, it should be noted that although the invalid user is less active in investment and wealth management and has fewer categories of investment and wealth management products in the past year, the asset allocation solution of the present specification is applicable to the invalid user.

In some implementations, the collecting resource data of a user includes continuously monitoring the on-line activities, events, and data of users in asset allocation and asset transaction through the internet platform or outside the platform. The monitoring ensures that not only a current status of the asset allocation, but also historical status of asset allocation of a user can be obtained and assembled into a data set for analysis. The richness of the data obtained through the monitoring enables the analysis of the resource allocation data of a user together with other characteristic factors of the user in determining the preference of the user in asset allocation, e.g., a risk preference coefficient parameter of the user. For example, the influence of other factors may be controlled so that the existing asset allocation status of the user can be used to estimate future asset allocation of the user. Such continuous monitoring of internet activities is enabled only through internet platform and is feasible only in the internet era of computing. Without internet technologies, it is impossible to monitoring the on-line asset allocation and transactions of a large number of users. Further, the choice of the type of data also facilitate the internet monitoring. The resource data can be obtained without human interference and input, which facilitates continuous monitoring in a large scale efficiently.

Step S220: Calculate a risk preference coefficient of the user based on the first risk resource data and the second risk resource data of the user, the proportion of the first risk resource data in the total resource data, and the proportion of the second risk resource data in the total resource data.

Specifically, the risk preference coefficient is usually used to measure the degree of an investor's aversion to risk, and the higher the degree of aversion, the higher the return compensation required for the investment risk.

In one or more implementations of the present specification, the risk preference coefficient of the user is calculated based on the asset data of the user obtained in step S210; for example, the current risk-return preference of the user is further deduced based on the current asset status of the user, so the derived risk-return preference is closer to the actual demand of the user. In an implementation of the present specification, the risk preference coefficient of the user can be calculated based on the following formula:

$$ARA = \frac{E [ R ] - 1}{W * x * Var [ R ]}$$

where ARA denotes the risk preference coefficient; E[R] denotes an expected return rate of total assets; W denotes total asset data; x denotes a proportion of first risk asset data in the total asset data or a proportion of second risk asset data in the total asset data; and Var [R] denotes the variance of the total asset data. In some implementations, variance of the total asset data may be calculated using the asset data of the user within a period of time. The assets data of the user within a period of time may include historical asset data and current asset data of the user.

In an example implementation, for example, if the risk asset of user A is valued as 60,000 yuan, the risk-free asset is valued as 40,000 yuan, and the total assets are 100,000 yuan, the proportion of the risk asset in the total assets is 60%, and the proportion of the risk-free asset in the total assets is 40%. Such resource data of a user may be obtained for a period of time such that a pool of a plurality of data sets may be obtained each indicating a proportion of the risk-free asset in the total assets of the user A. Using the pool of data, linear regression (E[R]−1=ARA*W*x*var [R]+ε) is performed based on the asset data of user A, and the resulting slope is an estimated absolute risk preference coefficient of user A. In the above linear regression formula, ε denotes the error term in the linear regression. In some implementations, the variables x and var [R] may be calculated using resource data of different time periods. For example, the variable x may be determined by resource data of a single time point, e.g., the current resource data, and the var [R] may be determined using resource data of a period of a year including the current resource data.

Step S230: Calculate a maximum utility value of a utility function based on a utility function model by using the risk preference coefficient as an input parameter, and determine a resource allocation ratio of the user based on the obtained maximum utility value.

Specifically, the utility function generally refers to a function of a quantitative relationship between utility obtained by a consumer in consumption and a combination of goods consumed, and is used to measure the degree of satisfaction that the consumer obtains from a given combination of goods consumed. In the present specification, the utility function is used to measure the degree of satisfaction that an investor obtains when investing in various assets.

In an implementation of the present specification, the maximum value of the utility function can be obtained based on the following formula:

max U(W_{*},ARA)

where W_{*} denotes an allocation ratio of an optimal risk asset; and ARA denotes the risk preference coefficient.

In the formula of the utility function, the risk preference coefficient ARA is a component of the utility function, and W_{*} is the only value that requires to be obtained in the formula. Since the ARA of each user is different, the form of the utility function is different.

Further, by maximizing the utility function U, it is possible to obtain the proportion W_{*} of the optimal risk assets of the user in the total assets, and then 1−W_{*} is the proportion of the optimal risk-free assets of the user in the total assets. In this implementation, the risk preference coefficient ARA of the user calculated in step S220 is incorporated into the utility function formula, the utility function is maximized, and the maximum utility value is obtained by calculating the value maximizing the utility function. The maximum utility value can be considered as the optimal risk asset proportion after optimal allocation is performed for the user. In the present specification, a portfolio solution can be systematically configured for each user to meet the user's own actual needs. The allocation ratio of the optimal risk asset indicates the optimal asset allocation solution that can be obtained by the user under the current risk preference coefficient ARA. In this implementation, the allocation ratio of the optimal risk asset of the user is represented by the value maximizing the utility function. In implementations, other indicators can also be used to describe the allocation ratio of the current optimal risk asset of the user.

As can be seen from the implementations herein, in step S210 to step S230, the asset data of the user is obtained, where the asset data of the user includes the current actual asset status of the user; then the current risk-return preference of the user is deduced based on the current asset status of the user, that is, the risk preference coefficient of the user is calculated based on the asset data of the user; and finally the utility function is maximized by using the risk preference coefficient of the user, and the maximum utility value obtained can be used as the allocation ratio of the optimal risk asset of the user under the current risk-return preference. Compared with the conventional wealth management method, the above method is more efficient and convenient without human participation. Compared with the online questionnaire, since the allocation of the current asset status of the user is optimized in the present specification, the current asset status of the user can reflect the actual investment demand of the user more accurately.

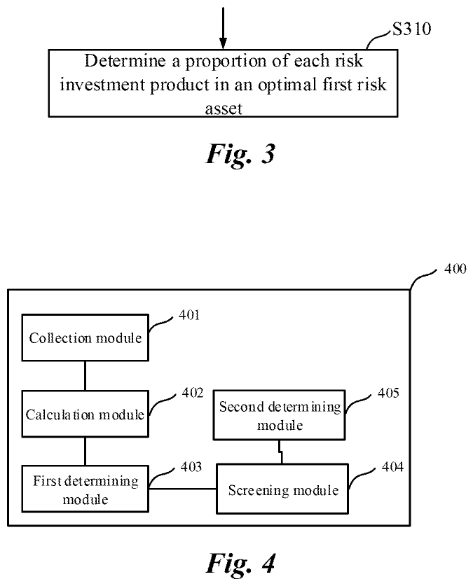

The above mainly describes the allocation of the proportion of the optimal risk asset and the proportion of the optimal risk-free asset in the total assets of the user based on the asset data of the user in the implementation of the present specification. In the implementation of the present specification, the proportion of each risk investment product in the optimal risk asset is further determined after the optimal risk asset is determined. FIG. 3 is a schematic flowchart of combining an optimal first risk asset according to an implementation of the present specification, which mainly includes the following steps:

Step S310: Determine a proportion of each risk investment product in the optimal first risk asset.

According to the asset separation theorem proposed by Tobin, the investor's attitude to investment risks will only affect the amount of investment in the risk asset, but will not affect the proportion of each risk investment product in the optimal risk asset. That is, the optimal weight of each risk investment product in the risk asset can be determined without knowing the investor's return and preference for risk investment.

In one or more implementations of the present specification, net value data of all risk investment products is obtained, expected return rates and covariance matrices of all the risk investment products are determined, and an objective function is solved using a mean-variance model to obtain a proportion of each risk investment product in an optimal risk asset. In an implementation of the present specification, the objective function can be solved based on the following formula: where the objective function is:

$$max \frac{{\sum }_{i = 1}^{N} {w}_{i} {u}_{i} - {r}_{f}}{\sqrt{{\sum }_{i , j = 1}^{N} {σ}_{i j} {w}_{i} {w}_{j}}}$$

a limitation on the objective function is:

$$S . t . {\sum }_{i = 1}^{N} {w}_{i} = 1$$

where wᵢ denotes a weight of risk investment product i; wⱼ denotes a weight of risk investment product j; uᵢ denotes an expected return rate of risk investment product i; r_{f} denotes a return of a risk-free asset; and σᵢⱼ denotes the covariance between the expected return rates of risk investment products i and j.

In an example implementation, net value data of all risk investment products, such as risk investment product i and risk investment product j, on a certain wealth platform (for example, Alipay) is obtained; and an expected return rate and a covariance matrix of each risk investment product is determined. Specifically: a historical daily return (daily return) for risk investment product i is entered, the expected return rate for risk investment product i is “average(daily return)”, and the covariance matrix is “covar(daily return)”; a historical daily return (daily return) of risk investment product j is entered, the expected return rate of risk investment product j is “average(daily return)”, and the covariance matrix is “covar(daily return)”. Finally, the objective function is solved by using the mean-variance model to obtain the proportion of each risk investment product in the optimal risk asset.

Still based on the above example implementation, as shown in Table 1, least risk investment product i and risk investment product j are included. The weight of risk investment product j in the optimal risk asset is 0.2, and the weight of risk investment product j in the optimal risk asset is 0.8.

| Risk investment product | Weight |
|---|---|
| Risk investment product i | 0.2 |
| Risk investment product j | 0.8 |

In an example implementation, for example, if it is determined in step S210 to step S230 that the optimal risk asset of the total assets of the user A is 50,000 yuan, the combination of the risk investment products in the optimal risk asset of the user A is determined based on the weights in Table 1 as follows: 10,000 yuan for risk investment product i and 40,000 yuan for risk investment product j.

Through step S310, based on the allocation ratios of the optimal risk asset and the optimal risk-free asset determined in step S210 to step S230, the optimal combination mode of individual risk investment products in the optimal risk asset is further determined, so the optimal asset allocation solution is customized for each user to maximize the investment utility of each user.

It should be noted that Markowitz's mean-variance model is used in the implementation of the present specification to solve the objective function to determine the product weight in the optimal risk asset. In implementations, the objective can be achieved in other ways, such as Black-Litterman and risk parity model.

It can be appreciated that in the described methods, the choice of the resource data of users facilitate large scale monitoring and collection of such data through the internet platform. The existing and historical asset allocation status of users are objective and can easily be monitored and collected without human interference and human input. In contrast, the traditional way of interviewing with users or collecting user data through questionnaire forms cannot be implemented in internet platform efficiently, which hampers the use of internet platforms in managing asset allocation. Using the traditional user data and traditional ways of collecting user data, the advantage of an internet-based platform cannot be fully achieved. As such, the methods of the specification enables the use of internet platform in managing asset allocation in a scale that cannot be achieved if the traditional types of user data or traditional ways of collecting user data is used.

Implementations of the present specification further provide a resource allocation apparatus. FIG. 4 shows the resource allocation apparatus according to the implementation of the present specification. The apparatus 400 mainly includes: a collection module 401, configured to collect resource data of a user, the resource data including first risk resource data and second risk resource data of the user, a proportion of the first risk resource data in total resource data, and a proportion of the second risk resource data in the total resource data; a calculation module 402, configured to calculate a risk preference coefficient of the user based on the first risk resource data and the second risk resource data of the user, the proportion of the first risk resource data in the total resource data, and the proportion of the second risk resource data in the total resource data; and a first determining module 403, configured to calculate a maximum utility value of a utility function based on a utility function model and by using the risk preference coefficient as an input parameter, and determine a resource allocation ratio of the user based on the obtained maximum utility value.

According to an implementation of the present application, the apparatus further includes a screening module 404, configured to determine the user based on a screening rule before the resource data of the user is collected, the screening rule including: users whose total frequency of purchasing or redeeming investment products is greater than a predetermined number of times, and users who invest in a number of categories of products greater than a predetermined number.

According to an implementation of the present application, the resource data includes asset data, and the calculation module 402 is specifically configured to calculate the risk preference coefficient of the user based on the following formula:

$$ARA = \frac{E [ R ] - 1}{W * x * Var [ R ]}$$

where ARA denotes the risk preference coefficient; E[R] denotes an expected return rate of total assets; W denotes total asset data; x denotes a proportion of first risk asset data in the total asset data and a proportion of second risk asset data in the total asset data; and Var [R] denotes the variance of the total asset data.

According to an implementation of the present application, the first determining module 403 is specifically configured to calculate the maximum utility value of the utility function based on the following formula:

max U(W_{*},ARA)

where W_{*} denotes an allocation ratio of an optimal first risk asset; and ARA denotes the risk preference coefficient.

According to an implementation of the present application, the first determining module 403 is further configured to use the obtained W_{*} as a proportion of the optimal first risk asset of the user in the total assets; and use 1−W_{*} as a proportion of an optimal second risk asset of the user in the total assets.

According to an implementation of the present application, the apparatus further includes a second determining module 405, configured to determine a proportion of each risk investment product in the optimal first risk asset.

According to an implementation of the present application, the second determining module 405 is specifically configured to: obtain net value data of all risk investment products, determine an expected return rate and covariance matrix of each risk investment product, and solve an objective function by using a mean-variance model to obtain the proportion of each risk investment product in the optimal first risk asset.

According to an implementation of the present application, the second determining module 405 is further configured to solve the objective function based on the following formula: where the objective function is:

$$max \frac{{\sum }_{i = 1}^{N} {w}_{i} {u}_{i} - {r}_{f}}{\sqrt{{\sum }_{i , j = 1}^{N} {σ}_{i j} {w}_{i} {w}_{j}}}$$

a limitation on the objective function is:

$$S . t . {\sum }_{i = 1}^{N} {w}_{i} = 1$$

where wᵢ denotes a weight of risk investment product i; wⱼ denotes a weight of risk investment product j; uᵢ denotes an expected return rate of risk investment product i; r_{f} denotes a return of the optimal second risk asset; and σᵢⱼ denotes the covariance between the expected return rates of risk investment products i and j.

An implementation of the present specification further provides an electronic device, including: a memory, a processor, and a computer program that is stored in the memory and can run on the processor, where the processor implements the above resource allocation method when executing the program.

Example implementations of the present application are described above. Other implementations fall within the scope of the appended claims. In some situations, the actions or steps described in the claims can be performed in an order different from the order in the implementation and the desired results can still be achieved. In addition, the process depicted in the accompanying drawings does not necessarily require a particular execution order to achieve the desired results. In some implementations, multi-tasking and concurrent processing is feasible or can be advantageous.

The implementations of the present specification are described in a progressive way. For same or similar parts of the implementations, mutual references can be made to the implementations. Each implementation focuses on a difference from the other implementations. Especially, an apparatus implementation, an electronic device implementation, a non-volatile computer storage medium implementation are basically similar to a method implementation, and therefore is described briefly; for related parts, reference is made to partial descriptions in the method implementation.

The apparatus, the electronic device, and the non-volatile computer storage medium provided in the implementations of the present specification correspond to the method. Therefore, the apparatus, the electronic device, and the non-volatile computer storage medium also have beneficial technical effects similar to a beneficial technical effect of the corresponding method. The beneficial technical effect of the method is described in detail above, so the beneficial technical effects of the corresponding apparatus, electronic device, and non-volatile computer storage medium are not described here again.

The present specification is described with reference to the flowcharts and/or block diagrams of the method, the device (system), and the computer program product based on the implementations of the present specification. It should be understood that each flow and/or block in the flowcharts and/or block diagrams, and combinations of flows and/or blocks in the flowcharts and/or block diagrams can be implemented by using computer program instructions. These computer program instructions can be provided for a general-purpose computer, a dedicated computer, an embedded processor, or a processor of another programmable data processing device to generate a machine, so the instructions executed by the computer or the processor of the another programmable data processing device generate a device for implementing a specific function in one or more processes in the flowcharts and/or in one or more blocks in the block diagrams.

In a typical configuration, a computing device includes one or more processors (CPU), one or more input/output interfaces, one or more network interfaces, and one or more memories.

The memory can include a non-persistent memory, a random access memory (RAM), a non-volatile memory, and/or another form that is in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. As defined herein, computer-readable media do not include transitory computer-readable media such as modulated data signals and carrier waves.

It should also be noted that terms “include”, “comprise” or any other variant thereof are intended to cover non-exclusive inclusion, so processes, methods, products or devices that include a series of elements include not only those elements but also other elements that are not explicitly listed, or elements inherent in such processes, methods, products or devices. An element described by “includes a . . . ” further includes, without more constraints, another identical element in the process, method, product, or device that includes the element.

The present specification can be described in the general context of computer executable instructions executed by a computer, for example, a program module. Generally, the program module includes a routine, a program, an object, a component, a data structure, etc., executing a specific task or implementing a specific abstract data type. The present application can also be practiced in distributed computing environments. In the distributed computing environments, tasks are performed by remote processing devices connected through a communications network. In the distributed computing environments, program modules can be located in local and remote computer storage media including storage devices.

The implementations of the present specification are described in a progressive way. For the same or similar parts of the implementations, mutual references can be made to the implementations. Each implementation focuses on a difference from the other implementations. Particularly, a system implementation is basically similar to a method implementation, and therefore is described briefly. For related parts, references can be made to related descriptions in the method implementation.

The above descriptions are merely examples of the present specification and are not intended to limit the present application. For persons skilled in the art, the present application can be subject to various modifications and variations. Any modification, equivalent replacement or improvement made within spirit and principles of the present application shall be included in claims of the present application.

The various embodiments described above can be combined to provide further embodiments. Aspects of the embodiments can be modified, if necessary, to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A resource allocation method, comprising:
monitoring internet resource allocation activities of users through an internet platform;
collecting resource data of a user based on the monitoring the internet resource allocation activities, the resource data including data on first risk resource and second risk resource of the user, and a proportion of the first risk resource in total resource of the user, and a proportion of the second risk resource in the total resource;
calculating a risk preference coefficient of the user based on at least one of the proportion of the first risk resource in the total resource or the proportion of the second risk resource in the total resource;
calculating a maximum utility value of a utility function based on a utility function model and by using the risk preference coefficient as an input parameter; and
determining a resource allocation ratio of the user based on the obtained maximum utility value.

2. The method according to claim 1, further comprising:
before the collecting the resource data of the user, determining a characteristic of the user based on a screening rule, the screening rule including:
a threshold on a frequency of purchasing or redeeming resource products by a user; and
a threshold on a number of categories of resource products of a user.

3. The method according to claim 1, wherein the resource data includes asset data, and the calculating the risk preference coefficient of the user includes calculating the risk preference coefficient of the user based on the following formula:
$$ARA = \frac{E [ R ] - 1}{W * x * Var [ R ]}$$
wherein ARA denotes the risk preference coefficient; E[R] denotes an expected return rate of total assets; W denotes total asset data; x denotes one of a proportion of first risk asset data in the total asset data or a proportion of second risk asset data in the total asset data; and Var [R] denotes a variance of the total asset data.

4. The method according to claim 3, wherein the calculating the maximum utility value of the utility function includes calculating the maximum utility value of the utility function based on the following formula:
max U(W_{*},ARA),
wherein W_{*} denotes a target allocation ratio of a target first risk asset; and ARA denotes the risk preference coefficient.

5. The method according to claim 4, wherein the determining the resource allocation ratio of the user based on the obtained maximum utility value includes:
using the obtained W_{*} as a proportion of the target first risk asset in the total assets of the user; and using 1−W_{*} as a proportion of a target second risk asset in the total assets of the user.

6. The method according to claim 5, further comprising:
determining a proportion of a risk resource product in the target first risk asset.

7. The method according to claim 6, wherein the determining the proportion of the risk resource product in the target first risk asset includes:
obtaining net value data of all risk resource products, determining an expected return rate and covariance matrix of each risk resource product, and solving an objective function by using a mean-variance model to obtain the proportion of each risk resource product in the target first risk asset.

8. The method according to claim 7, wherein the solving the objective function by using the mean-variance model to obtain the proportion of each risk resource product in the target first risk asset includes solving the objective function based on following formula:
$$max \frac{{\sum }_{i = 1}^{N} {w}_{i} {u}_{i} - {r}_{f}}{\sqrt{{\sum }_{i , j = 1}^{N} {σ}_{i j} {w}_{i} {w}_{j}}} , and$$
$$S . t . {\sum }_{i = 1}^{N} {w}_{i} = 1$$
wherein wᵢ denotes a weight of a risk resource product i; wⱼ denotes a weight of a risk resource product j; uᵢ denotes an expected return rate of the risk resource product i; r_{f} denotes a return of the target second risk asset; and σᵢⱼ denotes covariance between the expected return rates of the risk resource products i and j.

9. A resource allocation apparatus, comprising:
a collection module, configured to monitor internet resource allocation activities of users through an internet platform and collect resource data of a user based on the monitoring the internet asset allocation activities, the resource data including data of first risk resource and data of second risk resource of the user, a proportion of the first risk resource in total resource of the user, and a proportion of the second risk resource in the total resource;
a calculation module, configured to calculate a risk preference coefficient of the user based on at least one of the proportion of the first risk resource in the total resource or the proportion of the second risk resource in the total resource; and
a first determining module, configured to calculate a maximum utility value of a utility function based on a utility function model and by using the risk preference coefficient as an input parameter, and determine a resource allocation ratio of the user based on the obtained maximum utility value.

10. The apparatus according to claim 9, further comprising:
a screening module, configured to determine a characteristic of the user based on a screening rule before the resource data of the user is collected, the screening rule including:
a threshold on a frequency of purchasing or redeeming resource products by a user, and a threshold on a number of categories of resource products of a user.

11. The apparatus according to claim 9, wherein the resource data includes asset data, and the calculation module is configured to calculate the risk preference coefficient of the user based on the following formula:
$$ARA = \frac{E [ R ] - 1}{W * x * Var [ R ]}$$
wherein ARA denotes the risk preference coefficient; E[R] denotes an expected return rate of total assets; W denotes total asset data; x denotes one of the proportion of first risk asset in the total asset or the proportion of second risk asset in the total asset; and Var [R] denotes a variance of the total asset data.

12. The apparatus according to claim 11, wherein the first determining module is configured to calculate the maximum utility value of the utility function based on the following formula:
max U(W_{*},ARA)
wherein W_{*} denotes a target allocation ratio of a target first risk asset; and ARA denotes the risk preference coefficient.

13. The apparatus according to claim 12, wherein the first determining module is further configured to:
use the obtained W_{*} as a target proportion of the target first risk asset of the user in the total assets; and use 1−W_{*}as a target proportion of a target second risk asset of the user in the total assets.

14. The apparatus according to claim 13, further comprising:
a second determining module, configured to determine a proportion of a risk resource product in the target first risk asset.

15. The apparatus according to claim 14, wherein the second determining module is configured to:
obtain net value data of all risk resource products, determine an expected return rate and covariance matrix of each risk resource product, and solve an objective function by using a mean-variance model to obtain the proportion of each risk resource product in the target first risk asset.

16. The apparatus according to claim 15, wherein the second determining module is further configured to solve the objective function based on following formula:
$$max \frac{{{\sum }^{N}}_{i = 1} {w}_{i} {u}_{i} - {r}_{f}}{\sqrt{{{\sum }^{N}}_{i , j = 1} {σ}_{ij} {w}_{i} {w}_{j}}} , \text{and}$$
$$S \cdot t {\sum }_{i = 1}^{N} {w}_{i} = 1$$
wherein wᵢ denotes a weight of a risk resource product i; wⱼ denotes a weight of risk resource product j; uᵢ denotes an expected return rate of the risk resource product i; r_{f} denotes a return of the target second risk asset; and σᵢⱼ denotes the covariance between the expected return rates of risk resource products i and j.

17. An electronic device, comprising:
a processor and a memory having executable instructions stored thereon, which when executed by the processor enable the processor to implement acts including:
monitoring internet resource allocation activities of users through an internet platform;
collecting resource data of a user based on the monitoring the internet resource allocation activities, the resource data including data on first risk resource and second risk resource of the user, and a proportion of the first risk resource in total resource of the user, and a proportion of the second risk resource in the total resource;
calculating a risk preference coefficient of the user based on at least one of the proportion of the first risk resource in the total resource or the proportion of the second risk resource in the total resource;
calculating a maximum utility value of a utility function based on a utility function model and by using the risk preference coefficient as an input parameter; and
determining a resource allocation ratio of the user based on the obtained maximum utility value.

18. The device according to claim 17, wherein the resource data includes asset data, and the calculating the risk preference coefficient of the user includes calculating the risk preference coefficient of the user based on the following formula:
$$ARA = \frac{E [ R ] - 1}{W * x * Var [ R ]} ,$$
wherein ARA denotes the risk preference coefficient; E[R] denotes an expected return rate of total assets; W denotes total asset data; x denotes one of a proportion of first risk asset data in the total asset data or a proportion of second risk asset data in the total asset data; and Var [R] denotes a variance of the total asset data.

19. The device according to claim 18, wherein the calculating the maximum utility value of the utility function includes calculating the maximum utility value of the utility function based on the following formula:
max U(W_{*},ARA),
wherein W_{*} denotes a target allocation ratio of a target first risk asset; and ARA denotes the risk preference coefficient.

20. The device according to claim 19, wherein the acts include determining a proportion of a risk resource product in the target first risk asset including:
obtaining net value data of all risk resource products, determining an expected return rate and covariance matrix of each risk resource product, and solving an objective function by using a mean-variance model to obtain the proportion of each risk resource product in the target first risk asset.
